(19) United States
(12) Patent Application Publication
(10) Pub. No.: US 2008/0298455 A1
(43) Pub. Date: Dec. 4, 2008

(54) CLOCK GENERATOR INCLUDING A RING OSCILLATOR WITH PRECISE FREQUENCY CONTROL

(75) Inventors: Ilia Greenblat, Cfar-Saba (IL); Amir Helzer, Cfar-Saba (IL)

Correspondence Address: OSTROLENK FABER GERB & SOFFEN, 1180 AVENUE OF THE AMERICAS, NEW YORK, NY, 100368403, US

(73) Assignee: INTERNATIONAL RECTIFIER CORPORATION, El Segundo, CA (US)

(21) Appl. No.: 11/958,053

(22) Filed: Dec. 17, 2007

Related U.S. Application Data
(60) Provisional application No. 60/870,161, filed on Dec. 15, 2006.

(51) Int. Cl. H04L 7/00

(52) U.S. Cl. 375/238; 375/371

(57) ABSTRACT

A clock generator for providing a desired system clock signal in accordance with an embodiment of the present application includes a ring oscillator operable to provide an oscillator output signal having a first frequency, a divider operable to divide the oscillator output signal by a predetermined divisor and to output the divided signal as the desired system clock signal, a reference device operable to provide a reference signal with a known second frequency and a ratio device operable to provide a ratio value indicative of a relationship between the oscillator output signal and the reference signal, wherein the predetermined divisor of the divider is determined based on the ratio value such that the desired system clock signal has a desired frequency.

### CROSS REFERENCE TO RELATED APPLICATION

The present application claims benefit of and priority to U.S. Provisional Patent Application No. 60/870,161 entitled DIGITAL TUNABLE CLOCK SCHEME FOR MICROCONTROLLER filed Dec. 15, 2006, the entire contents of which are hereby incorporated by reference herein.

### BACKGROUND OF THE INVENTION

1. Field

The present invention relates to an improved clock generator. In particular, the present application relates a clock generator utilizing a ring oscillator with precise frequency control.

2. Related Art

A ring oscillator is generally formed by an odd number of NOT gates, or inverters, connected together in series. The output of the last inverter is connected to the first inverter to form a ring. Since an odd number of inverters are used, the output of the last inverter will be the opposite of the value input to the fist inverter. Since this output is then provided to the first inverter, the output of the last inverter will then change again to the opposite value. Thus, the result is an oscillating output signal which may be used to provide a clock signal, for example. Since each of the inverters has a certain gate delay, the frequency of the output signal can be adjusted by adding, or subtracting pairs of inverters. The more inverters used, the more gate delay introduced to the circuit and the lower the frequency of the oscillator output signal. In addition, the value of the voltage supplied will also affect frequency as well as the heat dissipated by the circuit. The type of silicon used may also affect frequency.

FIG. 1 illustrates an exemplary embodiment of a ring oscillator 10 including a plurality of inverters 12 that provide a 1 Ghz oscillator output signal. The input signal (run) provided to the first inverter via the NAND gate 14 is used to trigger the beginning of oscillation. Since ring oscillators are relatively easy to implement and typically take up little room, it is common to use them to provide a clock signal in a computer system, or for a microcontroller. However, the output of ring oscillator tends to be somewhat inaccurate and difficult to precisely control. Naturally, such features are undesirable in generating a clock signal

Accordingly, it would be beneficial to provide a clock generator using a ring oscillator that avoids these problems.

### SUMMARY OF THE INVENTION

It is an object of the present invention to provide a clock generator that provides a desired clock signal, wherein the clock generator includes a ring oscillator.

A clock generator for providing a desired system clock signal in accordance with an embodiment of the present application includes a ring oscillator operable to provide an oscillator output signal having a first frequency, a divider operable to divide the oscillator output signal by a variable divisor and to output the divided signal as the desired system clock signal, a reference device operable to provide a reference signal with a known second frequency and a ratio device operable to provide a ratio value indicative of a relationship between the oscillator output signal and the reference signal, wherein the variable divisor of the divider is determined based on the ratio value such that the desired system clock signal has a desired frequency.

Other features and advantages of the present invention will become apparent from the following description of the invention which refers to the accompanying drawings.

### BRIEF DESCRIPTION OF THE DRAWING(S)

FIG. 1 is an illustration of a conventional ring oscillator;

FIG. 2 is an illustration of a modified ring oscillator including a selectable fast mode and a selectable slow mode;

FIG. 3 is an illustration of a clock generator circuit in accordance with an embodiment of the present application;

FIG. 4 A is a table indicating divided values of a 1 Ghz oscillator output signal;

FIG. 4B is a table indicating divided values of a 0.7 Ghz oscillator output signal;

FIG. 5 is a more detailed illustration of the ratio calculator and reference device of the clock generator of FIG. 3;

FIG. 6 is an illustration of a master cycle counter of a pulse width modulation control device of the clock generator of FIG. 3;

FIG. 7 is an illustration of a phase counter of a pulse width modulation control device of the clock generator of FIG. 3; and

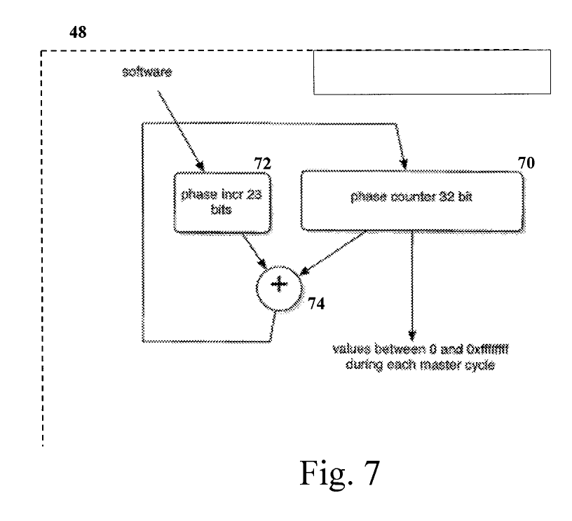

FIG. 8 is an illustration showing more detail of the pulse width modulation control device of the clock generator of FIG. 3.

### DETAILED DESCRIPTION OF PREFERRED EMBODIMENTS OF THE INVENTION

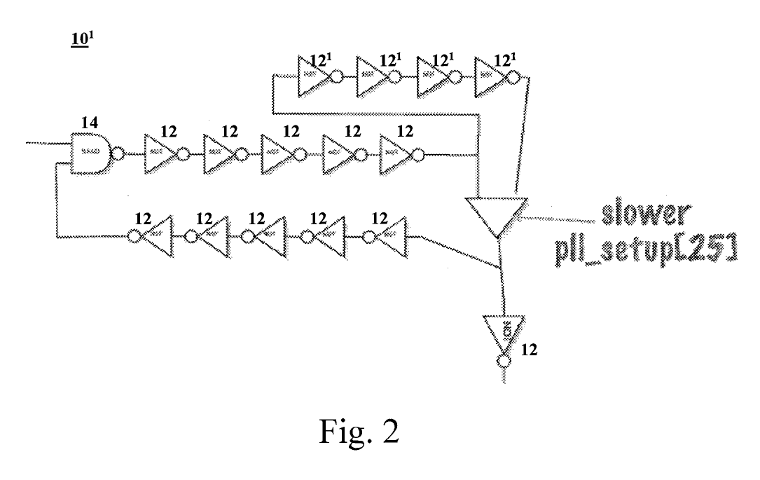

FIG. 2 illustrates an example of a modified ring oscillator 10¹ that may work in two modes, a fast mode and a slow mode. The frequency of the oscillator 10¹ is faster in the fast mode than in the slow mode. In this case, additional inverters 12¹ may be selectively added to the series to slow down the frequency of the oscillator. The slower mode is triggered by a control signal (slower pll_setup) that is preferably provided by a phase lock loop (PLL) (not shown). The use of a phase lock loop in clock and/or oscillator control is well known, and thus, will not be discussed in detail herein.

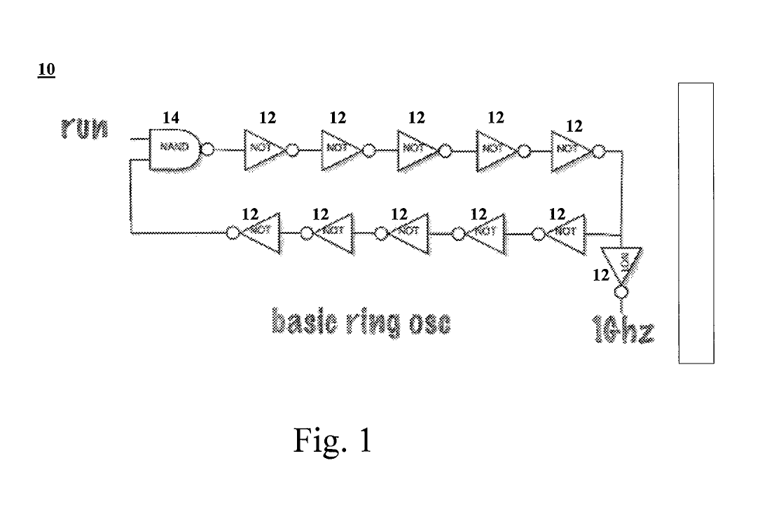

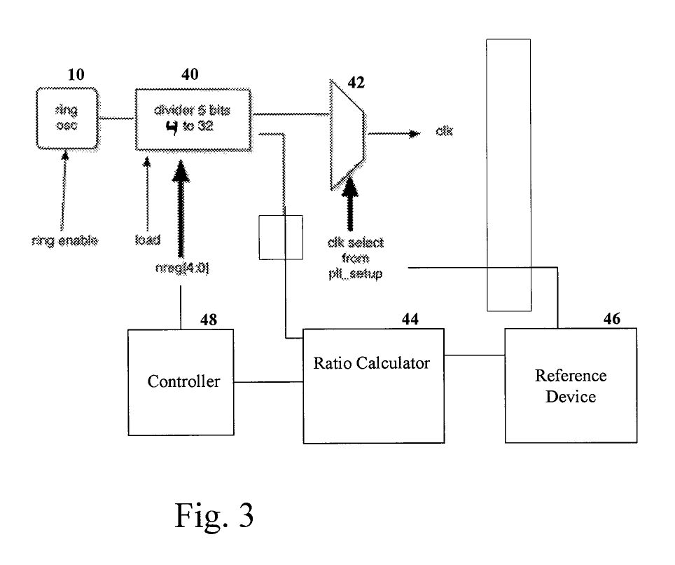

FIG. 3 illustrates a schematic diagram of a clock generator 100 that utilizes a ring oscillator 10 to provide a desired clock signal (elk) in accordance with an embodiment of the present application. In FIG. 3, the output of the ring oscillator 10 is preferably a 1 Ghz signal, similar to that provided by the ring oscillator 10 of FIG. 1. This signal is divided by the divider 40 to reduce the 1 GHz output of the ring oscillator 10 to a more usable value. Preferably, the divisor utilized by divider 40 is an integral between 4 and 32. This value is provided by the nreg signal and is intended to produce a clock signal elk with the desired frequency. The ring oscillator 10 may receive an enabling signal (ring enable) from a control device, either the controller 48, the PLL discussed above, or any other suitable control element. This signal enables the oscillator 10. A select signal (elk select) may be used to select the circuit 100 as the provider of the system clock. The clock signal (elk) is preferably provided via the multiplexor, or mux, 42 based on the select signal, which is preferably provided from the controller 48, the PLL, or other control circuit. The divider 40 is preferably a 5 bit divider, however, it need not be limited to this specific embodiment.

When the generator 100 is selected to be the system clock, via the select signal (elk select), the ring oscillator 10 is enabled by the enabling signal ring enable and a dividing factor is written to the nreg signal. This value is preferably selected as an integer value between 4 and 32 and is based on the desired frequency for the system clock. Thus, the system clock may be set in stepped values between 250 MHz (1 Ghz/4) and 32 MHz (1 GHz/32).

It is noted that the oscillator 10, divider 40 and mux 42 alone could be used to provide the clock signal elk. However, as noted above, ring oscillators, such as oscillator 10 tend to be inaccurate and present a problem for precise frequency control since the frequency is adjusted in steps. For example, the oscillator output signal may have a frequency that varies by as much as 30% from an expected output frequency. Since the divider 40 only divides by integer values, the clock signal elk can only be adjusted in stepped intervals. Thus, setting a precise clock frequency is difficult. In addition, the steps also tend to be irregular in interval, which makes it even more difficult to set the desired clock frequency.

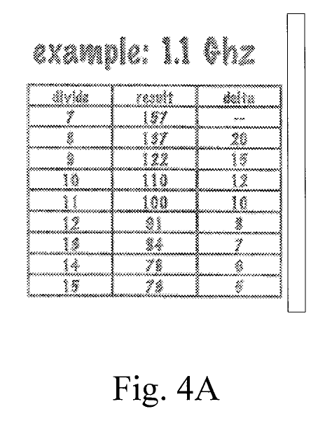

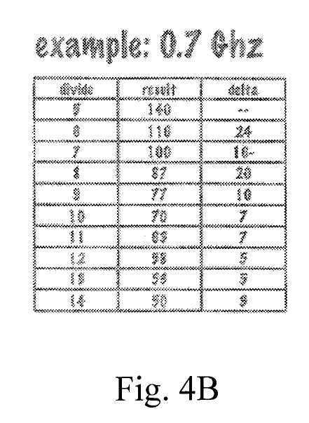

FIGS. 4A and 4B illustrate the irregular intervals (see the delta column) between the steps for exemplary ring oscillators having a 1.1 GHz output frequency and a 0.7 GHz output frequency, respectively. As can be seen in the tables of FIGS. 4A and 4B the intervals between steps are very irregular, which complicates selecting the proper divisor to use in the divider 40 to provide a desired frequency for the clock signal elk.

Since it is difficult to predict the output frequency of the ring oscillator 10 with any accuracy, and it is difficult to determine exactly what value should be used to divide this signal to provide the desired clock signal, the clock generator 100 of the present application measures the actual frequency provided by the oscillator and then adjusts other parameters to provide the desired clock signal. In this manner, there is no need to accurately predict the frequency of the oscillator output signal since it can be simply measured.

Thus, the clock generator 100, of the present application includes a ratio calculator 44 used to provide a ratio value that indicates a relationship between the oscillator output signal and a reference signal provided by the reference device 46. This ratio value is then utilize to determine the preferred integer value to be provided to the divider 40 as the divisor to provide a clock signal with the desired frequency. The ratio value is also used in pulse width modulation (PWM) control in the generator 100 as well. In a preferred embodiment, the controller 48 uses the ratio value to calculate a divisor to be provided to the divider 40.

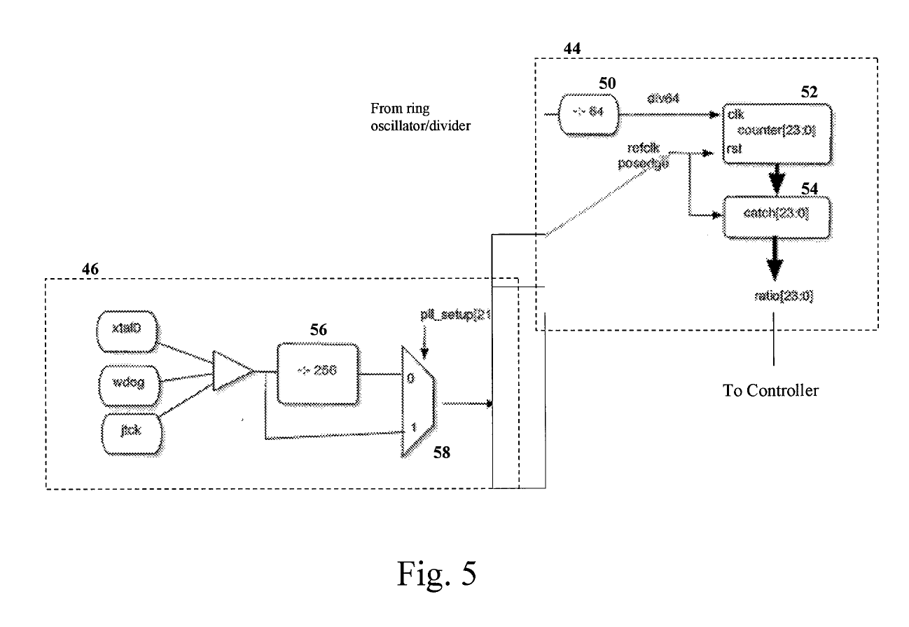

FIG. 5 illustrates a more detailed view of the ratio calculator 44 and the reference device 46 of FIG. 3. The ratio calculator 44 preferably includes a second divider 50 which divides the output signal from the output of the divider 40, by 64. The output div64 of this divider 50 is provided to the counter 52. The counter 52 also receives a reference signal refclk from the reference device 46. The counter circuit 52 counts the number of pulses in the div64 signal that occur during one period of the reference signal. This count is passed to the catch device 54 which provides the ratio signal ratio which represents the number of div64 pulses in the period of the reference signal. Alternatively, the oscillator output signal itself may be provided to the divider 50 to provided the div64 signal.

The reference device 46 selects a reference source from one of the signals xtal0 and wdog. In a testing environment, the reference source may be obtained from the signal jtck. In all cases, the frequency of the signal selected from the reference source is known. This reference source signal may be divided by 256 by a third divider 56. This may be useful when the reference source frequency is relatively high such that dividing it by 256 brings it within a more usable range. Either the divided signal from divider 56, or the undivided signal, may be provided as the reference signal refclk to the ratio calculator 44. This selection is preferably made via mux 58, based on the control sign (pll_setup[21]), which is provided from the controller 48, the PLL, or any other control device.

As noted above, the ratio signal (ratio) is preferably used to determine the desired divisor for the divider 40 in FIG. 3, for example. This is preferably done in the controller 48. For example, presuming that the source reference signal has a frequency of 1.5 MHz, the period is 667 ns. When this signal is divided by 256, in divider 56, the period of the resulting signal is 171 microseconds. If the ring oscillator 10 provides a divided signal with a frequency of 1056 MHz, when this is divided by 64, the resulting signal div64 has a frequency of 16.5 MHz and a period of 60.60 ns. In this case, by dividing 171 microseconds/60.60 ns, in the counter and catch circuit 52, 54 for example, the ratio value is provided as 2834. This value is then used by the controller 48 to determine the proper divisor for the divider 30 to produce a clock signal clk with the desired frequency.

Presuming that the target, or desired, clock frequency is 64 MHz, the controller 48 selects the best divisor for the divider 40 to provide this frequency. In particular, the ratio 2834 is divided by 171 and multiplied by 64/64 to yield the factor of approximately 16. Since this factor is based on the actual output of the ring oscillator 10, the fact that the frequency of the oscillator output signal cannot be accurately predicted is irrelevant. Thus, the value 16 is then provided to the divider 30 via the signal nreg to produce the desired 64 MHz clock signal clk.

In selecting the reference signal, or reference clock signal there are certain limits to keep in mind. In order to get 1% accuracy or better, the ratio value should preferably be above 150. The slowest useful div64 signal has a period of 90 ns. If we multiply the period of the slowest possible useful div64 signal (90 ns) by the minimum ration value (150) the result is 13.5 microseconds. This means that the fastest reference signal, divided by 256 should have a period of 13.5 microseconds. If we divide 13.5 microseconds by 256, the result is 52 ns which corresponds to a frequency of 20 MHz. Thus, the fastest usable reference signal should have a frequency of 20 MHz. The lowest reference signal is preferably in the range of a few hertz.

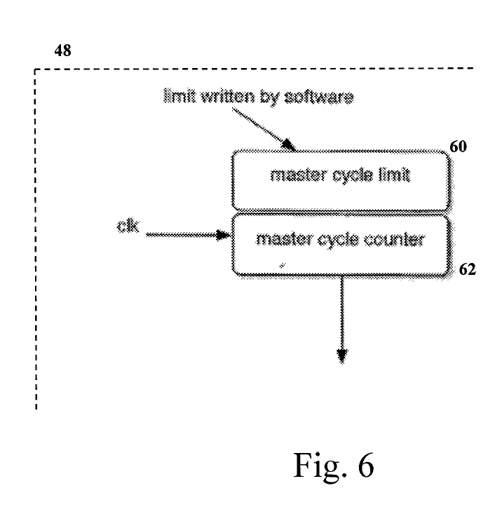

The ratio value is also used to determine the master cycle used in pulse width modulation (PWM) control. More specifically, as shown in FIG. 6, the master cycle limit is based on the ratio value, this limit is preferably calculated by software, preferably in the controller 48, for example. This limit may be stored in the master cycle limit register 70. The master cycle counter 72 is connected to the clock signal (clk) and the cycle limit register 70. The counter 72 cycles from 0 up to the limit set based on the ratio. The master cycle is used to generate SYNC pulses. PWM control may be incorporated into the controller 48 or may utilize the controller 48 to provide control signals to control the generator 100.

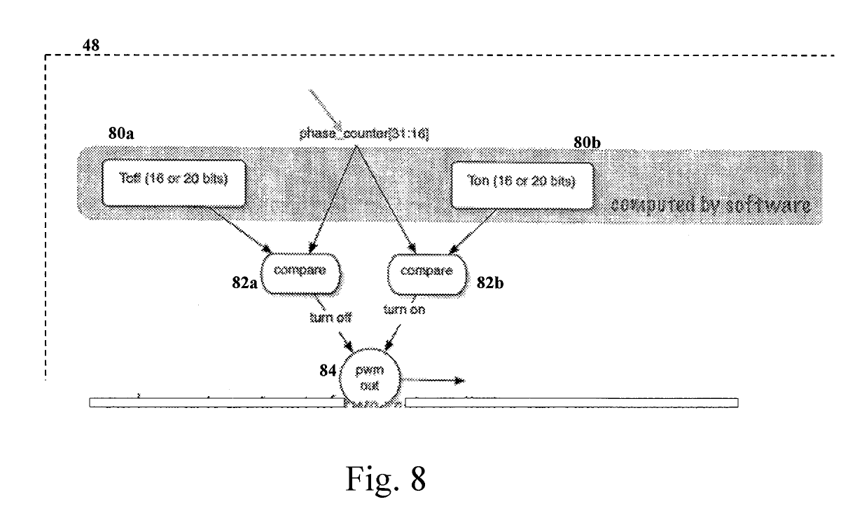

As illustrated in FIG. 8, a single phase counter 80 is preferably provided which adjusts the fastest PWM control in the system. Slower PWM control units within the system utilize 4 additional bits to reduce their carrier frequency by a factor of up to 16. During each master cycle, the phase counter 80 goes from 0 to a maximum integer value (maxint (0xffffffff)) in increments set in the increment register 82. The value set in the increment register 82 is preferably based on the ratio value discussed above.

Each PWM signal is preferably provided using two register limits (Ton, Toff) stored in the registers 80a, 80b, respectively. The two comparators 82a, 82b compare the respective limits to the phase counter output, and the result is provide to the PWM output node 84 which provided a PWM signal based on these comparisons. The limits Ton and Toff are preferable calculated in the controller 48, or other control circuit. The counter 80 counts through all values and thus Ton and Toff always catch the correct edges. The values Ton and Toff preferably stay constant relative to clock frequency.

Thus, the clock generator of the present application provides a clock signal clk with a frequency that can be suitably controlled despite the inaccuracy common in ring oscillators. Taking a measure of the actual oscillator output signal allows the generator to correct for inaccuracy to provide a suitable clock signal. Thus, the clock generator 100 of the present application provides a suitably accurate clock signal while using an inexpensive ring oscillator.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A clock generator for providing a desired system clock signal comprises:
a ring oscillator operable to provide an oscillator output signal having a first frequency;
a divider operable to divide the oscillator output signal by a variable divisor and to output the divided signal as the desired system clock signal;
a reference device operable to provide a reference signal with a known second frequency; and
a ratio device operable to provide a ratio value indicative of a relationship between at least one of the oscillator output signal and divided signal, and the reference signal, wherein the variable divisor of the divider is determined based on the ratio value such that the desired system clock signal has a desired frequency.

2. The clock generator of claim 1, further comprising a multiplexor operable to selectively provide the desired clock signal from the divided signal of output from the divider.

3. The clock generator of claim 2, wherein the reference device further comprises a reference source operable to provide a reference source signal having a known frequency.

4. The clock generator of claim 3, wherein the reference device further comprises:
a divider operable to divide the reference source signal be a first constant divisor to provide a divided reference source signal; and
a multiplexor operable to provide the reference signal based on a selection signal, wherein reference signal is one of the reference source signal and the divided reference source signal, depending on a value of the selection signal.

5. The clock generator of claim 4, wherein the ratio calculator further comprises:
a third divider operable to divide at least one of the output oscillator signal and the divided signal by a second constant divisor to provide a ratio divided signal;
a counter operable to count a number of pulses of the ratio divided signal in a set period of time, wherein the set period of time is the period of the reference signal from the reference device; and
a ratio output device operable to generate the ratio value based on the number of pulses in the ratio divided signal present during one period of the reference signal.

6. The clock generator of claim 5, wherein the controller calculates the predetermined divisor for the divider based on the ratio value and a desired frequency of the desired clock signal.

7. The clock generator of claim 5, wherein the controller further comprises a PWM control unit operable to provide a PWM control signal to control the clock generator, wherein the controller sets a master cycle limit of the PWM control unit based on the ratio value.

8. The clock generator of claim 5, wherein the controller further comprises a phase counter that count phases during the master cycle, when the PWM control signal is based on a comparison of a count of the phase counter to at least one predetermined count value.

9. The clock generator of claim 8, wherein the controller further comprises a first comparator and a second comparator, wherein the first comparator compares the count of the phase counter to a predetermined turn on count value and the second comparator compares the count the count of the phase counter to a predetermined turn off count.
